(19) United States
(12) Patent Application Publication
(10) Pub. No.: US 2020/0390646 A1
(43) Pub. Date: Dec. 17, 2020

(54) SKINCARE DEVICE

(71) Applicant: Dae Hee CHO, Daegu (KR)

(72) Inventor: Day JOH, Daegu (KR)

(21) Appl. No.: 16/966,262

(22) PCT Filed: Nov. 28, 2019
(86) PCT No.: PCT/KR2019/016613

§ 371 Date: Jul. 30, 2020

(30) Foreign Application Priority Data
Nov. 30, 2018 (KR) 10-2018-0152568

(51) Int. Cl. A61H 23/02

(52) U.S. Cl. CPC A61H 23/0245; A61H 2201/0207; A61H 2201/50; A61H 2201/013

(57) ABSTRACT

The present invention presents a skincare device that includes a suction unit wherein the first hole wherein a vacuum is formed in the internal space by a vacuum pump and a protruding unit that protrudes from the outer periphery of the first hole into said internal space; and an ultrasound generating unit wherein a connection hole corresponding to said first hole is formed and which is placed on the outside of said protruding unit so said protruding unit is inserted into said connection hole to generate ultrasound.

### TECHNICAL FIELD

The present art relates to a skincare device.

Particularly, it concerns a skincare device that delivers ultrasonic stimulation deeply into the skin by irradiating the skin with ultrasonic waves along the edges surrounding the circumference of the vacuum space that is in close contact with the skin and stimulates the capillaries to facilitate blood circulation and waste elimination.

### BACKGROUND ART

Generally, most of the prior art are related to heating devices that produce a warming effect by applying heat to the portion in contact with the skin in order to improve blood circulation in the skin.

Conventional skincare devices are multifunctional cosmetic devices that implement the functions of ultrasonic massage, cold and hot massage, ion introduction/extraction by galvanic ions, and vibration massage, as a single device, as confirmed in the domestic public utility model application number 20-2017-0005103, and the embodiments of the multifunctional cosmetic device of the prevention include a base body provided with multiple ventilation holes; an upper cover coupled to the base body; a body that is coupled to the upper cover in a detachable manner and equipped with a head that supplies ions while in contact with the user's skin; a thermoelectric element unit that is coupled to the body and emits warm or cold energy to the skin through the head; a heat-releasing unit that is provided in the base body and releases heat from the thermoelectric element unit by introducing outside air through the multiple ventilation holes; an ultrasound generating unit provided in the head that generates ultrasonic waves; and a vibrating unit that is provided in the upper cover and vibrates the head.

Most of such conventional skincare devices have been able to perform one of the functions of vacuum, ultrasonic irradiation, and vibration, but the operation and/or sealing thereof were incomplete, rendering it impossible to maintain a vacuum while irradiating ultrasonic waves at the same time. For this reason, the effect of improving blood circulation by conventional skincare devices was marginal.

These issues have arisen from skincare device structures. Therefore, there is growing demand among users of skincare devices for skincare devices with a blood circulation improvement effect that has been enhanced by enabling ultrasonic irradiation in vacuum by improving the skincare device structure.

### DESCRIPTION OF THE INVENTION

### Technical Problem

An object of the present invention is to improve the structure and functions of skincare devices to provide a skincare device that is capable of ultrasonic irradiation in a vacuum. The ultrasound and vacuum actions work closely with each other, yet airtightness is maintained to ensure that they are mutually independent functions. This is to provide a skincare device that has the effects of dissolving waste products in the capillaries inside the skin and promoting their discharge outside the skin at the same time.

The technical issues to be addressed by the present invention are not limited to the technical issues mentioned above, and other technical issues not mentioned should be clearly understood, from the following descriptions, by any person with ordinary knowledge in the technical field to which the present invention belongs.

### Technical Solution

The present invention provides a skincare device that includes a suction unit, wherein there is the first hole formed by a vacuum created in the internal space by a vacuum pump and a protruding unit that protrudes from the outer periphery of the first hole into the internal space; and an ultrasound generating unit wherein a connection hole corresponding to the first hole is formed and which is placed outside said protruding unit for said protruding unit to be inserted into said connection hole to generate ultrasonic waves.

Here, said ultrasound generating unit may provide a skincare device characterized by inclusion of a piezoelectric element wherein the first connection hole connected to the first hole is formed and which is placed in contact with the outer peripheral surface of the protruding unit; and a stopper which is place on one surface of said piezoelectric element to secure said piezoelectric element to one surface of said suction unit, provided that said first hole and said connection hole linked to said first connection hole are formed therein; provided that said stopper may protrude into the internal space of said suction unit from one side and include a signal transmission terminal for transmitting signals to said piezoelectric element.

Here, said piezoelectric element may provide a skincare device characterized by inclusion of the first terminal and the second terminal that are comprised of different poles and are placed away from each other; an insulation unit surrounding either the first terminal or the second terminal to insulate the first terminal and the second terminal; and a conductive unit placed at one of the terminals to supply power to one of the terminals insulated by said insulation unit.

Here, said signal transmission terminal may provide a skincare device characterized by formation of the positive terminal on the inside and the negative terminal on the outside, with the positive terminal formed in such a way that the poles of the first terminal and the second terminal of said piezoelectric element are in contact with each other, thereby transmitting signals to said piezoelectric element.

Here, said ultrasonic generating unit may provide a skincare device characterized by inclusion of a fixing unit attached to one side of said stopper and wherein the third connection hole is formed on the inside to connect to said first connection hole and said second connection hole, provided that one area of said fixing unit is cut and said third connection hole is open.

Here, the part of said cap coming into contact with the skin that is formed to have a prescribed degree of elasticity and becomes compressed to the skin upon contact may provide a skincare device characterized by maintaining the amount of ultrasonic waves generated by said piezoelectric element to be transmitted to the skin.

### Effects of the Invention

The present invention ensures that the ultrasound and vacuum actions work closely with each other, yet airtightness is maintained to ensure that they are mutually independent functions, in order to provide a skincare device that facilitates ultrasonic irradiation in a vacuum state by improving the structure and functions of the skincare device. This can dissolve waste products in the capillaries inside the skin and promote their discharge outside the skin at the same time.

### BRIEF DESCRIPTIONS OF THE DRAWINGS

FIG. 1 is a perspective view of the skincare device of the present invention.

FIG. 2 is a side view of the skincare device of the present invention.

FIG. 3 is a cross-sectional view of the skin care device of the present invention.

FIG. 4 is a drawing showing the piezoelectric element of the ultrasonic generating unit of the present invention.

FIG. 5 is a cross-sectional view of the skincare device of the present invention.

### SPECIFIC DETAILS FOR IMPLEMENTATION OF THE INVENTION

Hereinafter, an embodiment of the present invention will be described in detail through exemplary drawings. However, this is not intended to limit the scope of the present invention.

In adding reference codes to the components of each drawing, it should be noted that the same components have the same reference codes, if possible, even if they are displayed on different drawings. In addition, in describing the present invention, when it is determined that a detailed description of related configuration or function that has been disclosed may obscure the subject matter of the present invention, such detailed descriptions will be omitted.

Also, the size, shape, etc. of the components shown in the drawings may be exaggerated for clarity and convenience of description. In addition, terms specifically defined in consideration of the configuration and operation of the present invention are only for describing the embodiments of the present invention and do not limit the scope of the present invention.

Throughout the specification, when a part is said to “include” a certain component, it means that it may further include other components, not exclude other components, unless stated otherwise. Also, terms such as “ . . . unit,” “ . . . equipment,” “module,” and “device” stated in the specification mean a unit that processes at least one function or operation, which may be implemented by a combination of hardware and/or software.

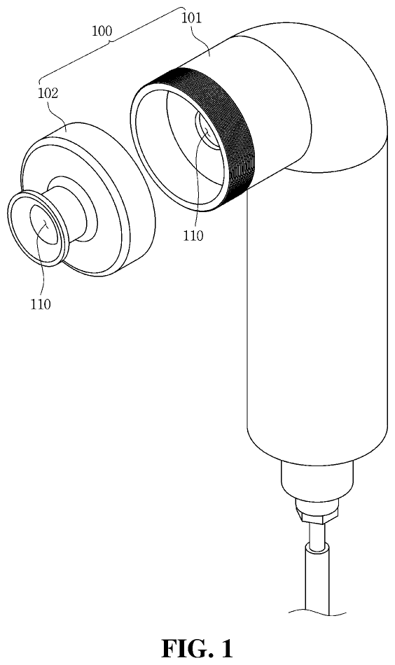

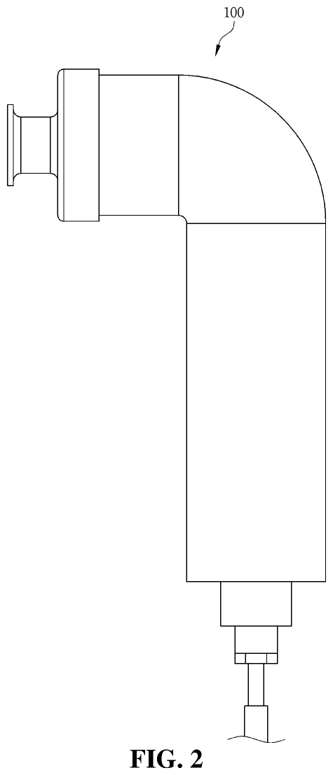

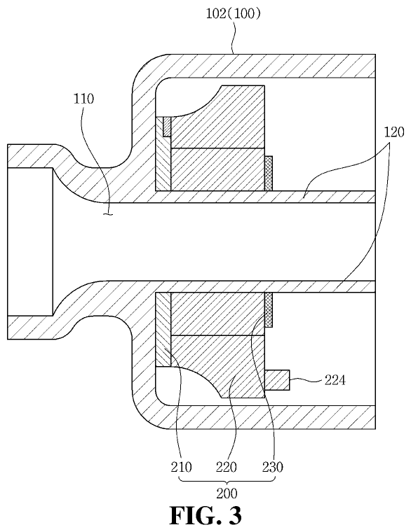

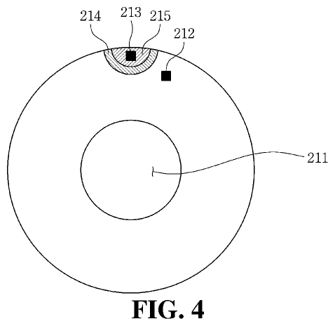

FIG. 1 is a perspective view of the skincare device of the present invention. FIG. 2 is a side view of the skincare device of the present invention. FIG. 3 is a cross-sectional view of the skin care device of the present invention. FIG. 4 is a drawing showing the piezoelectric element of the ultrasonic generating unit of the present invention.

Referring to FIGS. 1 to 4, the skincare device of the present invention includes a suction unit (100) and an ultrasound generating unit (200).

The suction unit (100) may include the main body (101) and the cap (102), and the first hole (110) is formed in the suction unit (100). The first hole (110) may be formed in the same manner as the main body (101) and the cap (102). The main body (101) of the suction unit (100) includes a part connected to the cap (102) and a part in the shape of a rod with a set length that bends from the part connected to said cap (102). The first hole (110) is connected to a suction device or a vacuum pump for forming a vacuum. That is, the first hole (110) may be formed to suck air into the space inside the suction unit (110). A vacuum may be formed inside the first hole (110) by a vacuum pump (not illustrated).

Also, the suction unit (100) may include a protruding unit (120) that protrudes from the outer periphery of the first hole (110) into the internal space.

The protruding unit (120) is formed along the circumference of the first hole (110), protruding into the space inside the suction unit (100), and the components of the ultrasound generating unit (200) to be described later may be placed on the outer periphery of the protruding unit (120). That is, the protruding unit (120) may be a part that protrudes outward for the ultrasound generating unit (200) to be located.

A space is formed inside the main body (101) and the cap (102). Such internal space may be connected to the first hole (110). Devices including the ultrasound generating unit (200) to be described later may be placed in the internal space of the suction unit (100). The main body (101) of the suction unit (100) is equipped with a handle for the user to grip and adjust its position. Although it is not illustrated in the drawings, inside the handle of the main body (101) there may be a suction device such as a hose, a motor, a power supply unit, a PCB board, etc.

The lower part of the suction unit (100) may be formed in a cylindrical shape which is open in the direction corresponding to the first hole (110). The upper part of the main body (101) of the suction unit (100) is connected to the cap (102), and this part may be formed in a cylindrical shape. A thread may be formed on the outer circumference of the upper part of the cap (102) of the cylindrical shape. The threads formed on the main body (101) may be coupled to the cap (102). However, the main body (101) and the cap (102) are not limited to coupling by threads. For example, the main body (101) and the cap (102) may be coupled by a fastening member such as a bolt.

The ultrasound generating unit (200) may be placed in the space inside the suction unit (100). The ultrasound generating unit (200) may include connection holes (211), (221), and (231), a piezoelectric element (210), a stopper (220), and a fixing unit (230).

The piezoelectric element (210) is placed in the space inside the suction unit (100), provided that it may be placed so that it is in contact with the inner surface of the cap (102). In this case, the piezoelectric element (210) may have the first connection hole (211) formed on the inside so that it becomes connected to the first hole (110). The diameters of the first hole (110) and the first connection hole (211) may correspond to each other.

Also, the piezoelectric element (210) may include the first terminal (212), the second terminal (213), the insulation unit (214), and the conductive unit (215).

Specifically, in the piezoelectric element (210), the first terminal (212) and the second terminal (213) may be placed. In this case, the first terminal (212) may be a negative terminal, and the second terminal (213) may be a positive terminal. The first terminal (212) and the second terminal (213) may be placed apart from each other at a prescribed interval and placed on the piezoelectric element (210).

In this case, in order to insulate the first terminal (212) and the second terminal (213), which have different poles, an insulation unit (214) may be placed between the first terminal (212) or the second terminal (213). More specifically, the insulation unit (214) may be placed in such a way to surround the peripheral area of the first terminal (212) or the second terminal (213). For example, the insulation unit (214) may surround the peripheral area of the second terminal (213), with both ends of the insulation unit (214) located on the outer periphery of the piezoelectric element (210).

In this case, in order to supply power to the second terminal (213), to which power transmission is blocked by the insulation unit (214), a conductive unit (215) may be placed in an area where the second terminal (213) is placed. Therefore, power may also be supplied to the second terminal (213). The conductive unit (215) may be made of such material as silver paste.

Therefore, the first terminal (212) and the second terminal (213) are insulated from each other, but power may be supplied to the first terminal (212) and the second terminal (213) each.

Vibration may be generated as power is supplied to the first terminal (212) and the second terminal (213), and ultrasonic waves may be generated.

In the present invention, the first hole (110) formed in the cap (102) of the suction unit (100), as above, comes into contact with the skin, and power is supplied to the piezoelectric element (210) later to generate ultrasonic waves. Therefore, ultrasound can be applied to the skin in a vacuum. If so, power must be applied to the piezoelectric element (210) in order to apply the above method. It may be possible to apply power to the piezoelectric element (210) through a signal transmission terminal (224) to be described later.

Here, the shape of the piezoelectric element (210) may be varied as a complete circle or polygons of various shapes, as necessary. Also, depending on the position and size of multiple piezoelectric elements (210) arranged in multiple directions, the range of the effects of ultrasound will vary due to the phase difference arising from the mutual combination of shapes, and a variety of functions and effects may be exhibited accordingly.

The stopper (220) is fixed to the inner side of the piezoelectric element (210), making it possible to secure the piezoelectric element (210) in the space inside the suction unit (100).

The stopper (220) may include the second connection hole (221) and a signal transmission terminal (224).

The second connection hole (221) is formed on the inside of the stopper (220) and may be connected to the first hole (110) and the first connection hole (211). For example, the first hole (110), the first connection hole (211), and the second connection hole (221) may be formed with diameters that correspond to each other.

The stopper (220) may be a part that comes into contact with the inner side of the piezoelectric element (210). The stopper (220) may be formed in a shape that is bent outward.

The signal transmission terminal (224) may be formed to protrude from the inner side of the stopper (220) to the inside of the internal space (that is, from the cap (102) toward the main body (101)). A positive terminal is formed on the outside of the signal transmission terminal (224) and a negative terminal is formed on the inside, and thus the positive terminal is formed in contact with the first terminal (212) of the piezoelectric element (210) to supply signals to the piezoelectric element (210). Such signal transmission terminal (224) may be connected to a control unit (not illustrated) placed on the inside of the main body (101) to receive signals.

The fixing unit (230) is fixed to the inner side of the stopper (220), making it possible to fix the piezoelectric element (210) and the stopper (220) to the space inside the suction unit (100).

The third connection hole (231) may be formed on the inside of the fixing unit (230). The third connection hole (231) may be connected to the first hole (110), the first connection hole (211), and the second connection hole (221). For example, the first hole (110), the first connection hole (211), the second connection hole (221), and the third connection hole (231) may be formed with diameters that correspond to each other. Therefore, the outside air suctioned by the first hole (110) of the suction unit (100) may be suctioned into the first connection hole (211), the second connection hole (221), and the third connection hole (231) inside the ultrasound generating unit (200).

Also, one area of the fixing unit (230) may be opened for the third connection hole (231) to be open. That is, when the fixing unit (230) is placed in contact with the stopper (220), the part of the fixing unit (230) corresponding to the signal transmission terminal (224) may be open in order to prevent interference by the signal transmission terminal (224) protruding from the stopper (220).)

In the present invention, the outer side of the ultrasound generating unit comes into contact with the skin through the first hole (110) of the suction unit (100), after which power is applied to the piezoelectric element (210) to generate ultrasonic waves, as described above. Therefore, ultrasound can be applied to the skin in a vacuum. Power must be applied to the piezoelectric element (210). It may be possible to apply power to the piezoelectric element (210) through a signal transmission terminal (224).

The present invention forms a vacuum through the first hole (110), the first connection hole (211), the second connection hole (221), and the third connection hole (231), as such, and thus it related to the capillary and pore exercise devices arising from the present invention. In such cases, the capillary and pore exercise devices use ultrasonic waves under the condition of vacuum pressure to apply micro-stimulation to the openings of capillaries, thereby improving blood circulation and facilitating waste elimination.

The ultrasound generating unit (200) generates ultrasonic waves outside the protruding unit (120). That is, the ultrasound generating unit (200) generates ultrasonic waves from the outside of the first hole (110), and as a result, vibration may be generated from the inside of the protruding unit (120). That is, the ultrasound generating unit (200) generates ultrasonic waves, and vibration may occur inside.

The skincare device of the present invention further includes a control unit (not illustrated).

The control unit (not illustrated) is connected to the vacuum pump (not illustrated) and the signal transmission terminal (224) to control the degree of vacuum and ultrasonic waves. The control unit (not illustrated) controls and maintains the suction power of the vacuum pump. Therefore, even if the suction unit (100) is moved, it maintains the power to suction the skin. Since the outside air is maintained at a constant force, it is possible to easily move the skin in all directions without exerting a large amount of force when the skin is suctioned.

The control unit (not illustrated) controls the vibration of the piezoelectric element (210) by the signal transmission terminal (224) and modulates the ultrasonic waves according to the control signal to be differentially applied according to the thickness of the skin, thereby applying 3 to 7 MHz to shallow layers of the skin and switching to 1 MHz when applied to the deep layers of the skin.

Here, the control unit (not illustrated) may store the frequency (Hz) of each ultrasonic wave in a preset memory, so when a control signal is applied, the data stored in the memory are loaded to operate the signal transmission terminal (224).

The ultrasonic waves controlled by the control unit and transmitted to the skin are prepared in sine wave or square wave to transmit ultrasonic waves in a frequency that ensures comfort, thereby improving the activity of beneficial microorganisms in somatic cells and facilitating blood circulation and waste elimination.

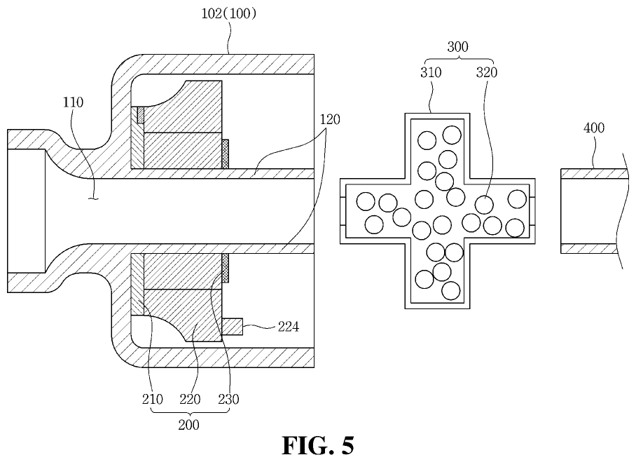

FIG. 5 is a cross-sectional view of the skincare device of the present invention.

Referring to FIG. 5, a filter unit (300) may be inserted into the first hole (110). For example, the filter unit (300) may be comprised of a sponge filter (320) disposed inside the filter case (310).

One end of the filter unit (300) may be formed in a shape and size enabling insertion into the first hole (110). The other end of the filter unit (300) may be formed in a shape and size enabling insertion into the hose unit (400). That is, one end of the filter unit (300) may be formed in a shape and size corresponding to the first hole (110), and the other end of the filter unit (300) may be formed in a shape and size corresponding to the hose unit (400).

One end of the hose unit (400) may be connected to the filter unit (300), and the other end may be connected to another configuration such as a vacuum unit.

Conventional devices generating high-intensity ultrasound have produced several side effects. For example, there have been many cases of cell damage caused by a positioning error during tumor removal in the past.

In order to eliminate these side effects, the present invention is a skincare device (1) that disperses low-intensity ultrasound. Low-intensity ultrasound prevents the aforementioned side effects and, at the same time, slowly transmits heat and waves for therapeutic purposes to the deep layers of the skin and activate healthy white blood cells and red blood cells, without damaging existing cells, so as to eliminate tumors or cancer cells as well as inflammation.

Specifically, the conventional ultrasonic devices have employed a method of applying ultrasonic waves therein and applying vacuum on the outside, but in the case of the skincare device (1) of the present invention, ultrasonic waves work on the outside and a vacuum works on the inside.

Applying ultrasonic waves outside the area where the vacuum is applied, as is the case with the skincare device (1) of the present invention, can generate heat and waves slowly and enable deeper penetration than the centralized type characterized by the conventional high-intensity focused ultrasound. At the same time, the vacuum acting in the center of the ultrasonic piezoelectric element (210) provides a passage through which waste products or inflamed tissues and cells present deep in the skin can be sucked out slowly, as a result of the thermal effects and waves. The passage through which the vacuum is delivered are the capillaries. This is made possible with the microscopic cells and molecules present in the capillaries transferring the vacuum energy deep into the core.

The ultrasonic waves generated from the skincare device (1) of the present invention can even penetrate through the cerebrovascular barrier. Specifically, since it can penetrate the brain blood barrier (BBB) to more than 10 cm deep into the cerebral blood vessels, it is possible to treat dementia using a non-invasive method. Arthritis can also be treated non-invasively. Specifically, this is because oxygen and nutrients are transported efficiently to the capillaries by unblocking obstructed capillaries. In this way, not only arthritis but also dementia can be treated. The core technology of the treatment using such skincare device (1) is the technology to eliminate inflammation without any side effects of inflammation, and it is to get rid of inflammation by transmitting heat and waves across a distance of at least 10 cm.

Although the present invention has been illustrated and described in connection with specific embodiments, the fact that the present invention may be variously improved and changed, within the limits that do not deviate from the technical idea of the present invention provided by the following claims, should be obvious to anyone with ordinary knowledge in the relevant industry.

1. A skincare device comprising:
a suction unit having the first hole, wherein a vacuum is formed in the internal space by a vacuum pump, and a protruding unit protruding from the outer periphery of the first hole into said internal space;
and an ultrasound generating unit, wherein a connection hole corresponding to said first hole is formed and which is placed on the outside of said protruding unit so said protruding unit is inserted into said connection hole to generate ultrasound.

2. A skincare device according to claim 1 characterized by said ultrasound generating unit comprising:
a piezoelectric element, wherein the first connection hole connected to said first hole is formed inside and which is placed in contact with the outer periphery of the protruding unit;
and a stopper, which is placed on one side of said piezoelectric element to fix said piezoelectric element to one side of said suction unit and inside of which the second connection hole connected to said first hole and said first connection hole is formed;
provided that said topper is formed to protrude from one side into the internal space of said suction unit and further comprises a signal terminal that supplies signals to said piezoelectric element.

3. A skincare device according to claim 2 characterized by said piezoelectric element comprising:
a first terminal and a second terminal comprising of different poles and are placed away from each other;
an insulation unit surrounding either said first terminal or said second terminal to insulate said first terminal and said second terminal;
and a conductive unit placed at one of the terminals to deliver ultrasonic signals to one of the terminals insulated by said insulation unit.

4. A skincare device according to claim 3 characterized by said signal transmission terminal,
wherein a positive terminal is formed on the inside and a negative terminal on the outside, with the positive terminal formed in such a way that the poles of the first terminal and the second terminal of said piezoelectric element are in contact with each other to transmit signals to said piezoelectric element.

5. A skincare device according to claim 4 characterized by said ultrasonic generating unit comprising:
a fixing unit attached to one side of said stopper and wherein the third connection hole is formed on the inside to connect to said first connection hole and said second connection hole;
provided that one area of said fixing unit is cut and said third connection hole is open.

6. A skincare device according to claim 5 characterized by a part of said cap coming into contact with the skin that is formed to have a prescribed degree of elasticity and becomes compressed to the skin upon contact, thereby maintaining the amount of ultrasonic waves generated by said piezoelectric element to be transmitted to the skin.
